(19) United States
(12) Patent Application Publication
(10) Pub. No.: US 2005/0023397 A1
(43) Pub. Date: Feb. 3, 2005

(54) Reel, recording tape cartridge and method of manufacturing the reel

(75) Inventor: Kazuo Hiraguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/892,320

(22) Filed: Jul. 16, 2004

(30) Foreign Application Priority Data
Jul. 31, 2003 (JP) 2003-284011

(51) Int. Cl. G11B 23/107

(52) U.S. Cl. 242/348

(57) ABSTRACT

A reel of a recording tape cartridge includes a reel hub formed in a bottomed cylindrical shape, an annular reel gear coaxially disposed at an outer surface of a bottom portion of the reel hub, and a through-hole the penetrates the axial center of the bottom portion and opens to an outer surface side of the bottom portion. The reel is resin-molded using a mold comprising a fixed mold, a movable mold and an insert. The reel gear and the through-hole are formed by a reel gear forming portion and a hole portion forming portion disposed in a single insert. As a result, the axial centers thereof are aligned with high precision.

### CROSS-REFERENCE TO RELATED APPLICATION

This application claims priority under 35 USC 119 from Japanese Patent Application No. 2003-284011, the disclosure of which is incorporated by reference herein.

### BACKGROUND OF THE INVENTION

1. Field of the Invention

The present invention relates to a reel wound with recording tape such as magnetic tape, a recording tape cartridge in which the reel is rotatably housed inside a case, and a method of manufacturing the reel.

2. Description of the Related Art

Recording tape such as magnetic tape is used as an external recording medium for computers and the like. A so-called single-reel recording tape cartridge, whose housing space at the time of storage is small, in which a large amount of information can be recorded and in which a single reel wound with recording tape is rotatably housed inside a case, is used for the recording tape.

In such a recording tape cartridge, a reel gear is annularly disposed at an end surface of a bottomed cylindrical hub of the reel wound with the recording tape. The reel gear projects through a gear opening in the case so that the reel gear is meshable with a drive gear disposed at a rotating shaft of a drive device. When the recording tape is to be pulled out from the case and used, a driving force is transmitted to the reel by the rotation of the rotating shaft in a state where the reel gear is meshed with the drive gear and is positioned in an axial line direction, so that the reel is rotatingly driven. The hub of the reel is configured so that the reel gear is integrally formed therewith by resin molding.

The reel is positioned in the axial line direction by the meshing of the reel gear with the drive gear. Specifically, mutual meshing surfaces are formed in tapered shapes at the teeth of the reel gear and the teeth of the drive gear, and the reel is positioned in the axial line direction in a state where the reel gear and the drive gear are meshed so that there is no backlash between these teeth. For this reason, an axial line-direction reference surface of the reel inside the drive device (at the time the reel is rotatingly driven) has served as, for example, a virtual surface that is a meshing pitch surface between the reel gear and the drive gear. In a recording tape cartridge disposed with such a reel, the design and dimensional evaluation of respective parts have been cumbersome because the dimensions of the respective parts have been determined on the basis of the virtual reference surface obtained by making the reel gear mesh with the drive gear.

Thus, a configuration has been devised where reference surfaces are disposed at an end surface of the hub of the reel separate from the reel gear so that the reel gear is not made to participate in the function of positioning the reel in the axial line direction (e.g., see the specification of U.S. Pat. No. 6,273,352). Specifically, three reference-use projections are disposed at equidistant intervals in the circumferential direction so as to project from the radial-direction outer side portion of the reel gear annually formed at the end surface of the hub, and reference surfaces that are surfaces orthogonal to the reel axial line at each reference-use projection are made to abut against a positioning surface of the rotating shaft, whereby the reel is positioned in the axial line direction.

However, in the configuration described in the specification of U.S. Pat. No. 6,273,352, there is the potential for the reel to become uncentered with respect to the rotating shaft because a slight backlash arises between the reel gear and the drive gear. For this reason, it may be considered that the projection disposed at the axial center portion of the rotating shaft is made to fit in a through-hole disposed in the bottom portion of the hub so that the reel is centered with respect to the rotating shaft.

Incidentally, the hub of the reel is molded by filling the space between a fixed mold and a movable mold (or the space between these and an insert) with a resin material. In a conventional hub, the reel gear and the through-hole have been formed by mutually different molds. Namely, in an instance where the reel gear is molded with a fixed mold, the through-hole is formed with a movable mold. For this reason, there have been instances where the mutual axial centers of the reel gear and the through-hole end up becoming skewed due to (dependent on) positional skewing of the movable mold with respect to the fixed mold. The amount of this uncenteredness is about 5 [symbol] m to about 15 [symbol] m, but becomes a factor in causing an unnecessary force to act on the through-hole or the reel gear in accompaniment with the rotational driving of the reel.

### SUMMARY OF THE INVENTION

In consideration of the above-described facts, the present invention provides a reel where a reel gear and a through-hole can be disposed at a hub with high precision. According to the invention, a recording tape cartridge that is disposed with only one of this reel, and with which recording tape can be stably pulled out from the reel, can be obtained.

A first aspect of the invention provides a reel disposed with a hub that includes a bottom portion, which reel is formed in a cylindrical shape and around whose outer peripheral surface recording tape is wound, with an annular reel gear formed coaxially with the cylindrical shape of the hub at an outer side of the bottom portion of the hub and a hole portion opening to an outer surface side of an axial center portion of the bottom portion being integrally formed with the reel by resin molding, and with the reel being rotatingly driven by a rotating shaft of a drive device in a state where a projection disposed at an axial center portion of the rotating shaft fits into and is centered in the hole portion and a drive gear of the rotating shaft is meshed with the reel gear, wherein the reel gear and an inner surface of the hole portion are formed by a reel gear forming portion and a hole portion forming portion integrally disposed in a common mold.

In the reel of the above-described aspect, the projection disposed at the axial center portion of the rotating shaft of the drive device fits into and is centered by the hole portion disposed at the outer surface side of the bottom portion of the hub, and the reel is rotatingly driven around the axial center due to the rotating shaft rotating in a state where the reel gear formed in an annular shape coaxial with the bottom portion outer side (end surface) of the hub meshes with the drive gear of the rotating shaft. Thus, the magnetic tape wound around the outer peripheral portion of the hub is pulled out and rewound.

Here, because the reel gear and the hole portion are formed by resin molding using a common (identical) mold where a gear-shaped reel gear forming portion and a convex hole portion forming portion are respectively disposed, the mutual axial centers of the annular reel gear and the hole portion positioned at the axial center of the hub do not become skewed due to mutual positional skewing as in an instance where the forming portions of the reel gear and the hole portion are disposed in separate molds. Thus, the axial center of the reel gear and the axial center of the hole portion are aligned with high precision.

In this manner, according to the above-described aspect, the reel gear and the through-hole can be disposed at the hub with high precision.

It should be noted that the common mold in the above aspect may be a fixed mold, a movable mold or an insert (insert mold/insert die). Also, although it is preferable for the hole portion to be a through-hole penetrating the bottom portion of the hub in an instance where the hole portion has the function of introducing a release member of a reel lock member preventing the rotation of the reel when the magnetic tape is not in use, it suffices as long as only the inner peripheral surface of the through-hole into which the projection of the rotating shaft fits is molded by the common mold. Moreover, a fitting surface of the hole portion with which the projection fits may be a cylindrical surface along the axial line direction of the reel or a tapered surface (conical surface, etc.) that intersects the axial line.

In the above aspect, the reel may further include a reference portion that is disposed at an outer side of the bottom portion of the hub, abuts against a positioning portion of the rotating shaft and is for positioning the reel in the axial line direction, wherein the reference portion is formed by a reference portion forming portion integrally disposed in the common mold.

In this reel, the reel is rotatingly driven as described above in a state where the reference portion of the hub abuts against the positioning portion of the rotating shaft and is positioned in the axial line direction. For this reason, because the reel includes the reference portion that is not dependent on the meshing of the reel gear with the drive gear, the design and dimensional management of the reel become simple.

Here, because the reference portion is formed by the reference portion forming portion integrally disposed in the common mold, the positional precision of the reference portion with respect to the reel gear and the hole portion is high. In particular, slanting of the reel axial line with respect to the rotating shaft axial line is reliably prevented because the reference portion has high positional precision with respect to the hole portion. The reference portion may be a reference surface that is a flat surface or curved surface and surface-contacts or line-contacts the positioning portion or point-contacts plural positioning portions, or may line-contact or point-contact a positioning portion that is a flat surface.

Additionally, by disposing the reference portion that conducts positioning in the reel axial line direction, backlash causing uncenteredness arises between the reel gear and the drive gear even if the teeth of the reel gear and the teeth of the drive gear are formed in mutually corresponding tapered shapes, but because uncenteredness (mainly uncenteredness in the radial direction) and slanting of the axial center are prevented as described above by the high-precision reel gear, hole portion and reference portion, the reel is rotatingly driven in a state where the reel is precisely centered with respect to the rotating shaft.

In the above aspect, the reel gear and the hole portion or the reel gear, the hole portion and the reference portion may be forming using, as the common mold, an insert mold where the reel gear forming portion and the hole portion forming portion or the reel gear forming portion, the hole portion forming portion and the reference portion forming portion are integrally disposed.

In an instance where an insert is used as the common mold, the reel gear and the hold portion, or the reel gear, the hole portion and the reference portion, are precisely formed as described above by the insert. Thus, the reel gear and the hole portion are made common and it becomes possible to easily accommodate design changes varying other portions (e.g., the length of the hub, flanges, etc.) of the reel and the manufacture of reels of other specifications. Conversely, other portions such as the flanges can be made common and it becomes easy to change the design of the reel gear and the hole portion.

In the above aspect, the reel may further include a first flange attached to an end portion of a bottom portion side of the hub and a second flange integrally formed by resin molding at an open end side of the hub opposite from the bottom portion side, wherein the outer peripheral surface of the hub and a surface of the second flange opposing the first flange are formed by a hub outer surface forming portion and an opposing surface forming portion integrally disposed in the common mold.

In this reel, the recording tape is wound around the outer peripheral surface of the hub in the space between the opposing surfaces of the first flange and the second flange. This reel is configured so that the reel gear, the hole portion and the outer peripheral surface of the hub are formed by a common mold with the recording tape side surface of the second flange, and the first flange is attached to the end portion of the bottom portion side of the hub after the hub and the second flange have been integrally molded.

Here, because the outer peripheral surface of the hub is formed by the common mold with the reel gear and the hole portion, the axial center of the outer peripheral surface of the hub around which is wound the recording tape is aligned with high precision with the axial centers of the reel gear and the hole portion. Namely, roundness with respect to the rotational center of the outer peripheral surface of the hub is improved. Also, a surface (surface opposing the second flange) of the second flange against which the recording tape abuts is precisely formed by the common mold with the outer peripheral surface of the hub.

Also, the recording tape cartridge may be configured so that one reel is rotatably housed inside a case of the recording tape cartridge in a state where the reel gear and the hole portion are exposed.

A second aspect of the invention provides a recording tape cartridge that houses a reel, the reel including a bottomed cylindrical hub around whose outer peripheral surface recording tape is wound, with an annular reel gear that is driven by a drive device when the recording tape cartridge is loaded in the drive device and the reel is rotated and a hole including an inner surface for defining a rotational center of the reel being formed in an outer portion surface of the bottom of the hub, wherein the reel gear and the hole are resin-molded by a single mold.

In this recording tape cartridge, a single reel is rotatably housed inside a case, and the reel gear and the hole portion of the reel are exposed to the outside. Thus, the reel can be driven by the rotating shaft of the drive device in a state where the recording tape wound around the outer peripheral surface of the hub is protected from dust and the like by the case.

Here, in this recording tape cartridge, the single reel is rotated and the recording tape is taken up at a take-up reel of the drive device when the recording tape is to be used, but because the single reel is the reel of the above-described aspect, the single reel is positioned with high precision with respect to (the rotating shaft of) the drive device and is stably rotatingly driven. For this reason, information can be recorded or played back while the recording tape wound around the single reel is stably pulled out or rewound.

In this manner, the above-described recording tape cartridge is disposed with only one of the reel and the recording tape can be stably pulled out from the reel.

As described above, the reel pertaining to the invention has the excellent effect that the reel gear and the through-hole can be disposed at the hub with high precision.

Also, the recording tape cartridge pertaining to the invention has the excellent effect that it is disposed with only one of the reel and the recording tape can be stably pulled out from the reel.

A third aspect of the invention provides a method of manufacturing a reel housed in a recording tape cartridge, the reel including a bottomed cylindrical hub around whose outer peripheral surface recording tape is wound, with an annular reel gear that is driven by a drive device when the recording tape cartridge is loaded in a drive device and the reel is rotated and a hole including an inner surface for defining a rotational center of the reel being formed in an outer portion surface of the bottom of the hub, the method including at least the steps of providing hub-use molds and injecting a resin material into the molds to resin-mold the hub, wherein the reel gear and the hole are both formed by a single mold.

### BRIEF DESCRIPTION OF THE DRAWINGS

FIGS. 1A and 1B are views showing the exterior of a recording tape cartridge pertaining to an embodiment of the invention, with FIG. 1A being a perspective view seen from above and FIG. 1B being a perspective view seen from below;

FIG. 2 is a cross-sectional view of the recording tape cartridge pertaining to the embodiment of the invention at a time when the recording tape cartridge is not in use;

FIG. 3 is a cross-sectional view of the recording tape cartridge pertaining to the embodiment of the invention at a time when a reel of the recording tape cartridge is rotatingly driven;

FIG. 4 is a cross-sectional view where relevant portions of the reel pertaining to the embodiment of the invention have been enlarged;

FIG. 5 is a cross-sectional view showing a mold for molding the reel pertaining to the embodiment of the invention;

FIG. 6 is a cross-sectional view showing a first modified example of the mold for molding the reel pertaining to the embodiment of the invention;

FIG. 7 is a cross-sectional view showing a second modified example of the mold for molding the reel pertaining to the embodiment of the invention; and

FIGS. 8A and 8B are views showing modified examples of the reel pertaining to the embodiment of the invention, with FIG. 8A being a cross-sectional view where a reel pertaining to a third modified example has been partially enlarged and FIG. 8B being a cross-sectional view showing a mold for forming the reel pertaining to the third modified example.

### DETAILED DESCRIPTION OF THE INVENTION

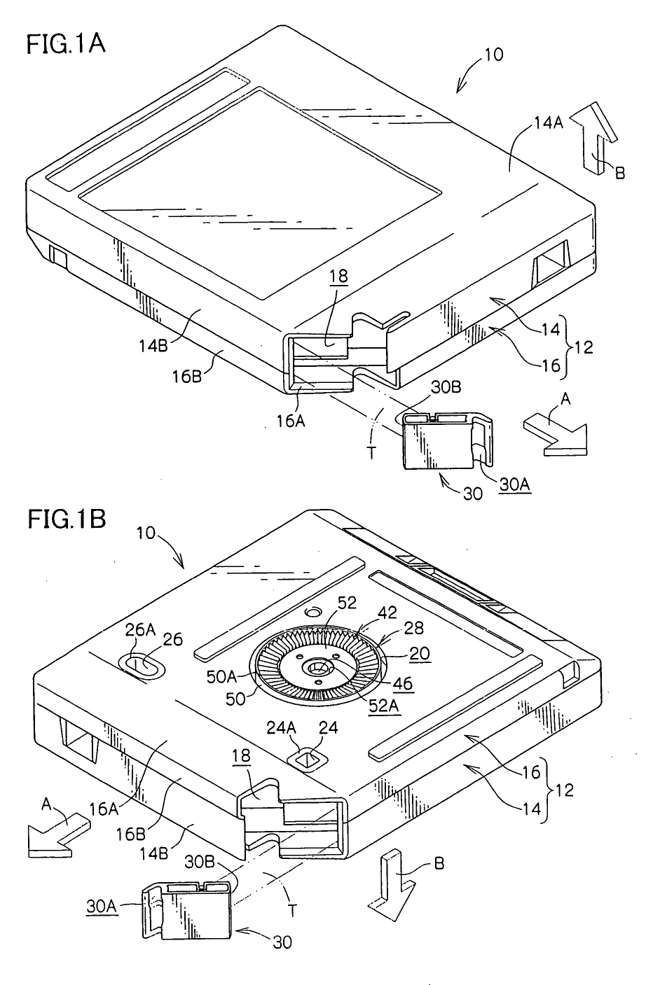

A recording tape cartridge 10 to which a reel 28 pertaining to an embodiment of the invention has been applied will be described on the basis of FIGS. 1A and 1B to FIG. 5.

(Overall Configuration of the Recording Tape Cartridge)

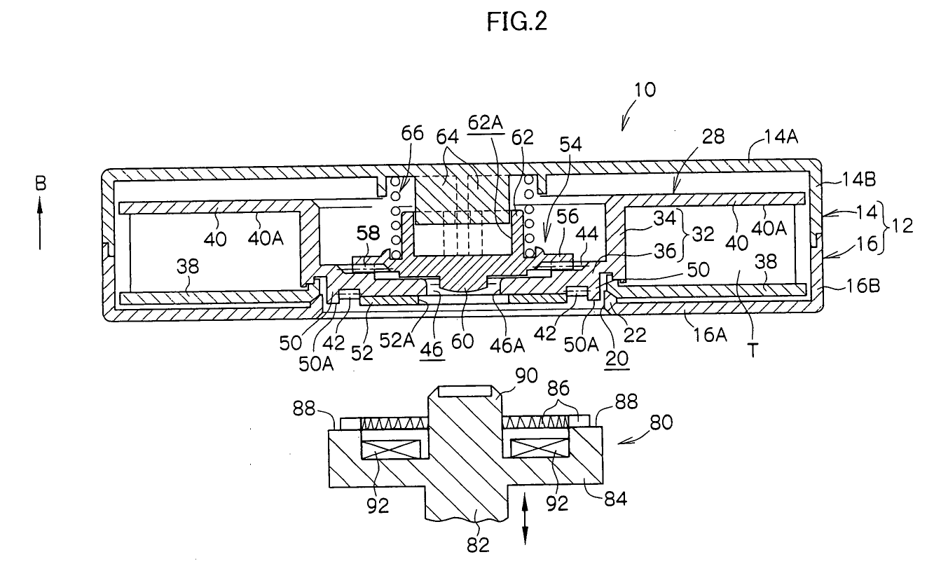

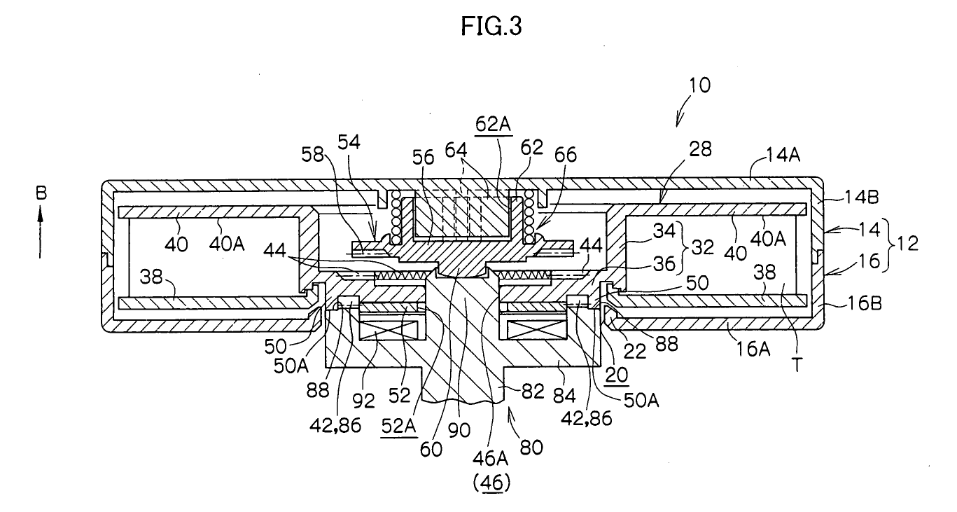

FIG. 1A is a perspective view of the recording tape cartridge 10 seen from diagonally above. FIG. 1B is a perspective view of the recording tape cartridge seen from diagonally below. FIGS. 2 and 3 are cross-sectional views of the recording tape cartridge 10. The arrow A appropriately shown in each drawing represents the direction in which the recording tape cartridge 10 is loaded in a drive device. For convenience of explanation, the side indicated by arrow A will be referred to as the front side, and the direction indicated by arrow B will be referred to as the top side.

As shown in these drawings, the recording tape cartridge 10 is disposed with a case 12. The case 12 is configured by joining together an upper case 14 and a lower case 16. Specifically, the upper case 14 is configured by a substantially frame-like peripheral wall 14B being vertically disposed along an outer edge of a top panel 14A that is substantially rectangular when seen in plan view. The lower case 16 is configured by a peripheral wall 16B being vertically disposed along an outer edge of a bottom panel 16A of a shape substantially corresponding to the top panel 14A. The upper case 14 and the lower 16 are joined together by ultrasonic welding or with screws in a state where the open end of the peripheral wall 14B and the open end of the peripheral wall 16B abut against each other, so that the case 12 is formed in a substantial box shape.

Corner portions of the top panel 14A, the peripheral wall 14B, the bottom panel 16A and the peripheral wall 16B at the leading side in the direction in which the case 12 is loaded in the drive device are respectively cut out to form in the case 12 an opening 18 that is slanted with respect to the loading direction. A circular gear opening 20 that penetrates the bottom panel 16A and is for exposing a later-described reel gear 42 is disposed in a substantially central portion of the bottom panel 16A. An annular rib 22 for positioning a later-described reel 28 is disposed at an edge portion of the gear opening 20 in the bottom panel 16A so as to project inward of the case 12.

Moreover, a pair of positioning holes 24 and 26 is disposed in a front end vicinity in an outer surface of the bottom panel 16A of the case 12. The positioning holes 24 and 26 are disposed in pocket shapes inside protrusions (not shown) vertically disposed inward of the case 12 from the bottom panel 16A, and are disposed mutually apart from each other on an imaginary line that is orthogonal to the loading direction. The positioning hole 24, which is closer to the opening 18, has a substantially square shape when seen from the bottom, and a positioning pin of the drive device is inserted therein. The positioning hole 26 is a long hole that is longitudinal along the imaginary line and has a width corresponding to the diameter of another positioning pin of the drive device.

Thus, when the recording tape cartridge 10 is loaded in the drive device and the positioning pins of the drive device are respectively inserted into the positioning holes 24 and 26, the recording tape cartridge 10 is precisely positioned in a horizontal direction (left and right, front and back) inside the drive device.

Moreover, portions around the positioning holes 24 and 26 in the bottom panel 16A serve as positioning surfaces 24A and 26A that are more smoothly finished than the other portion (design surface) of the bottom panel 16A. When the positioning pins of the drive device are inserted into the positioning holes 24 and 26, the positioning surfaces 24A and 26A abut against positioning surfaces of the drive device disposed around the positioning pins. Thus, the recording tape cartridge 10 is also positioned in a vertical direction inside the drive device.

As shown in FIG. 2, the reel 28 is rotatably housed inside the case 12. Only one reel 28 is disposed. Magnetic tape T serving as recording tape is wound around the reel 28, and a leader block 30 serving as a pullout member is attached to a leading end of the magnetic tape T.

When the recording tape cartridge 10 is not in use, the leader block 30 is housed and retained at the inner side of the opening 18 of the case 12. In this state, the leader block 30 closes off the opening 18 to prevent dust and the like from entering the case 12. An engagement recess 30A is formed in a leading end of the leader block 30. When the magnetic tape T is to be pulled out inside the drive device, the magnetic tape T is pulled out from the case 12 by pullout means that engages with the engagement recess 30A and is guided to a take-up reel of the drive device. Moreover, the end surface of the leader block 30 opposite from the engagement recess 30A is formed as an arced surface 30B. The arced surface 30B is fitted into the take-up reel to configure part of a take-up surface taking up the magnetic tape T.

(Configuration of the Reel)

Next, the reel 28 will be described. As shown in FIGS. 2 and 3, the reel 28 is disposed with a reel hub 32 serving as a hub configuring an axial center portion of the reel 28. The reel hub 32 is formed in a substantially bottomed cylinder shape that includes a cylindrical portion 34 having an outer peripheral surface 34A wound with the magnetic tape T and a bottom portion 36 that closes off the lower portion of the cylindrical portion 34. An upper flange 40 serving as a second flange is integrally disposed at the open end (upper end) of the cylindrical portion 34 of the reel hub 32 so that the upper flange 40 is coaxial with and extends in the radial-direction outer side of the open end of the cylindrical portion 34. Due to the upper flange 40 being integrally formed with the open end side of the cylindrical portion 34, the reel hub 32 has a strong (rigid) configuration.

A lower flange 38 serving as a first flange formed in correspondence to the upper flange 40 is joined to the lower end portion of the cylindrical portion 34 by welding. Specifically, an intermediate step of the lower end portion of the cylindrical portion 34 formed in a substantially stepped shape serves as a joint surface 34B. In a state where the joint surface 34B is made to abut against a joint portion 38A vertically disposed from an inner edge portion of the lower flange 38, the joint surface 34B and the joint portion 38A are welded together.

Thus, the magnetic tape T is wound, between opposing surfaces of the lower flange 38 and the upper flange 40, around the outer peripheral surface 34A of the cylindrical portion 34 of the reel hub 32 of the reel 28. The magnetic tape T is wound around the reel hub 32 towards one of the lower flange 38 or the upper flange 40, but in the present embodiment the magnetic tape T is wound towards the upper flange 40 (not shown). That is, an opposing surface (lower surface) 40A of the upper flange 40 opposite from the lower flange 38 serves as an abutment surface against which the magnetic tape T abuts.

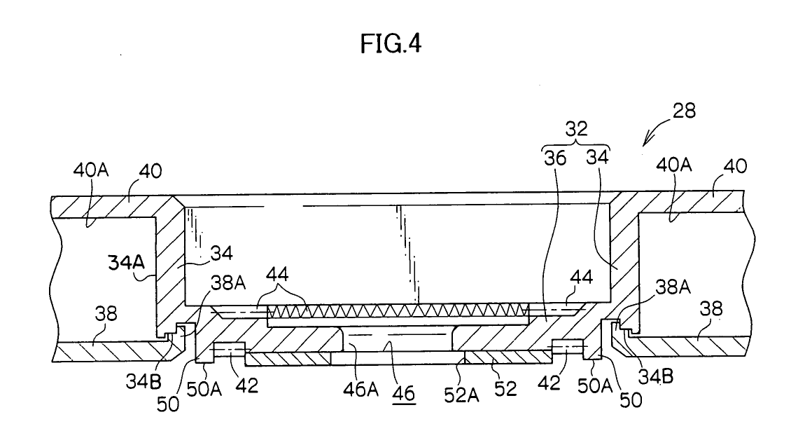

As shown in FIG. 4, the reel gear 42, which is formed in an annular shape coaxial with the reel 28 overall, is disposed at a lower end surface (outer surface) of the bottom portion 36 of the reel hub 32. The reel gear 42 is meshable with a drive gear 86 disposed at a leading end of a rotating shaft 80 (described later) of the drive device. An engagement gear 44, which is formed in an annular shape coaxial with the reel 28 overall, is disposed in an outer peripheral vicinity of an upper surface (inner surface) of the bottom portion 36 of the reel hub 32. The engagement gear 44 is meshable with a brake gear 58 of a later-described brake member 54.

Moreover, a through-hole 46 that serves as a hole portion and penetrates the axial center portion of the bottom portion 36 in the plate thickness (vertical) direction is disposed in the bottom portion 36. The through-hole 46 is a round hole whose upper edge portion is rounded. An inner surface of the straight portion of the through-hole 46 excluding the rounded upper portion that defines the through-hole 46 serves as a fitting surface 46A with which a projection 90 of the rotating shaft 80 fits so that the projection 90 is slidable in the axial line direction. The fitting surface 46A is a round cylindrical surface coaxial with the reel 28, and the length thereof in the axial line direction is 1 mm to 3 mm (and preferably 2 mm to 3 mm).

Moreover, a reference projection 50 is disposed so as to project from the lower end surface of the bottom portion 36. A reference surface 50A serving as a reference portion is formed at a lower end surface of the reference projection 50. In the present embodiment, the reference projection 50 is disposed adjacent to the radial-direction outer side of the reel gear 42. It should be noted that the reference projection 50, i.e., the reference surface 50A, may be plurally disposed at equidistant intervals on a circumference coaxial with the reel 28 (the reference surface 50A in FIG. 1B is annularly shown).

The portions of the above-described reel 28 excluding the lower flange 38 are integrally formed by resin molding. This resin molding will be described later. A punched discoid reel plate 52 comprising a magnetic material is coaxially and integrally disposed, by insert molding, at an inner side of the rear gear 42 in the lower surface of the bottom portion 36 of the reel hub 32. The axial center portion of the reel plate 52 is formed as a through-hole 52A. The inner diameter of the through-hole 52A is larger than the inner diameter of the through-hole 46. Thus, the inner edge of the reel plate 52 is prevented from interfering with the projection 90 of the rotating shaft.

The reel 28 is housed in the case 12 and rests on the annular rib 22 when not in use. Specifically, the inner edge vicinity of the lower flange 38 abuts against the annular rib 22 (see FIG. 2). Due to the reference projection 50 being inserted at the inner side of the annular rib 22, the movement of the reel 28 in the radial direction is regulated. In the present embodiment, the inner edge portion of the lower flange 38 and the upper portion of the annular rib 22 are formed in mutually corresponding tapered shapes, whereby this also regulates the movement of the reel 28 in the radial direction.

In this state, the reel 28 is positioned inside the case 12 and the reel gear 42 and the reel plate 52 are exposed through the gear opening 20 (see FIG. 1B). Namely, the reel gear 42 is exposed to the outside of the case 12 through the gear opening 20 without projecting from the outer surface (lower surface) of the bottom panel 16A. Thus, the reel 28 can be operated from the outside of the case 12, i.e., the reel 28 can be chucked (retained) and rotatingly driven from the outside of the case 12.

Also, when the reel 28 is not in use, rotation of the reel 28 with respect to the case 12 is prevented. Specifically, the brake member 54 is inserted inside of the cylindrical portion 34 of the reel hub 32. The brake member 54 includes the drive gear 58, which is meshable with the engagement gear 44, and a main body portion 56, which is formed in a substantially discoid shape. The drive gear 58 is disposed at an outer peripheral portion of a lower surface of the main body portion 56. Moreover, a release protrusion 60 is disposed so as to project from the axial center portion of the lower surface of the main body portion 56.

A cross-shaped protrusion 62, in which is formed an engagement groove 62A that is cross-shaped when seen in plan view, is disposed so as to project from an upper surface of the main body portion 56. A cross-shaped rib 64, which is disposed so as to project from the top panel 14A, is inserted in the engagement groove 62A of the cross-shaped protrusion 62. Thus, the break member 54 cannot rotate with respect to the case 12 and is guided by the cross-shaped rib 64 so as to be slidable in the vertical direction. Also, a compression coil spring 66 is disposed in a compressed state between the upper surface of the main body portion 56 of the brake member 54 and the top panel 14A.

The brake member 54 is urged downward by the urging force of the compression coil spring 66 to cause the brake gear 58 to mesh with the engagement gear 44. Due to the meshing of the brake gear 58 with the engagement gear 44, a locked state is created where the rotation of the reel 28 with respect to the case 12 is prevented. In this state, the protrusion 60 is positioned inside the through-hole 46. Also, the reel 28 is made to abut against the annular rib 22 by the urging force of the compression coil spring 66.

The locked state resulting from the brake member 54 is released by loading the reel 28 in the drive device so that the drive gear 86 of the rotating shaft 80 meshes with the reel gear 42.

The rotating shaft 80 is configured by the drive gear 86 being formed in a coaxial annular shape at an upper surface of a discoid rotating table 84 disposed at a tip end of the rotating shaft 82. Also, the radial-direction outer side portion of the drive gear 86 at the upper surface of the rotating table 84 serve as a positioning surface 88 against which the reference surface 50A of the reel 28 abuts. The positioning surface 88 is formed as a flat surface along a plane orthogonal to the axial line of the rotating shaft 80. Moreover, the projection 90 that is insertable and fittable in the through-hole 46 of the reel 28 is disposed so as to project from the axial center portion of the upper surface of the rotating table 84. The projection 90 has a height such that it can move as far as a position where the brake member 54 is released from the meshed state with the engagement gear 44 when the projection 90 is inserted in the through-hole 46 and presses the release protrusion 60 of the brake member 54. Also, a magnet 90 is attached to the upper surface of the rotating table 84 between the projection 90 and the drive gear 86. The magnet 92 attracts and retains, without contacting, the reel plate 52 of the reel 28.

When the release protrusion 90 is pressed by the projection 90 and the brake member 54 is pushed upward in accompaniment with an operation that causes the reel gear 42 to mesh with the drive gear 86, the meshing between the engagement gear 44 and the brake gear 58 is released so that the reel 28 becomes rotatable with respect to the case 12. Also, the reel 28 is centered with respect to the rotating shaft 80 due to the projection 90 fitting in the fitting surface of the through-hole 46, and the reel 28 is positioned in the axial line direction due to the positioning surface 88 of the rotating shaft 80 abutting against the reference surface 50A. In a state where the reel 28 is positioned in the axial line direction, the reel 28 rises inside the case 12 and becomes separated from the annular rib 22. Thus, as shown in FIG. 3, the reel 28 becomes rotatable around an axial line without contacting the case 12.

(Mold for Molding the Reel)

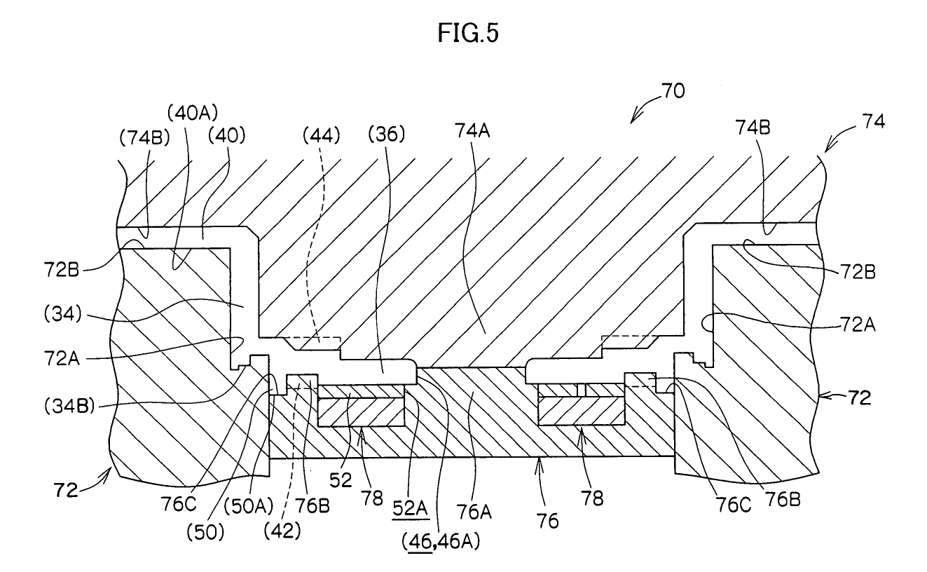

Next, a mold for resin-molding the reel hub 32 and the upper flange 40 of the reel 28 will be described. The reel hub 32 and the upper flange 40 are resin-molded using a mold 70 shown in FIG. 5. It should be noted that reference numerals in brackets pointing to the spaces formed by the mold 70 of FIG. 5 correspond to portions of the reel 28 formed by the mold 70.

The mold 70 is configured by a fixed mold 72, a movable mold 74 and inserts 76 and 78. The fixed mold 72 includes a cylindrical portion outer surface forming portion 72A, for forming the lower end portion of the reel hub 32 including the outer peripheral surface 34A and the joint surface 34B of the cylindrical portion 34, and an opposing surface forming portion 72B, for forming the opposing surface 40A of the upper flange 40. The cylindrical portion outer surface forming portion 72A and the opposing surface forming portion 72B are integrally formed. The draft angle of the cylindrical portion outer surface forming portion 72A (outer peripheral surface 34A of the cylindrical portion 34) is set to be substantially 0°.

The movable mold 74 includes a hub inner surface forming portion 74A, which is inserted in the cylindrical portion outer surface forming portion 72A and forms the inner surface of the reel hub 32 (cylindrical portion 34 and bottom portion 36) including the engagement gear 44 and the upper portion of the through-hole 46 whose edge portion is rounded, and an upper flange outer surface forming portion 74B, which opposes the opposing surface forming portion 72B and is for forming the upper surface of the upper flange 40. The hub inner surface forming portion 74A and the upper flange outer surface forming portion 74B are integrally formed. The draft angle of the hub inner surface forming portion 74A (inner peripheral surface of the cylindrical portion 34) is set to be substantially 2°.

The insert 76 that is inserted into the fixed mold 72 and opposes the lower portion of the hub inner surface forming portion 74A includes a convex hole portion forming portion 76A for forming the lower portion of the through-hole 46 whose edge portion serves as the fitting surface 46A, a gear-shaped reel gear forming portion 76B for forming the reel gear 42, and a reference portion forming portion 76C for forming the reference surface 50A (reference projection 50). The hole portion forming portion 76A, the reel gear forming portion 76B and the reference portion forming portion 76C are integrally formed. The upper end surface of the hole portion forming portion 76A abuts against the lower end surface of the portion of the hub inner surface forming portion 74A forming the upper portion of the through-hole 46 in order to form the through-hole 46 penetrating the bottom portion 36. Also, the draft angle of the hole portion forming portion 76A (fitting surface 46A) is set to be substantially 0°.

The insert 78 is inserted in the insert 76 to insert-mold the reel plate 52. The hole portion forming portion 76A of the insert 76 is stepped, fits into the reel plate 52 and also positions the reel plate 52 in the radial direction. This is made possible so that the annular portion of the reel 28 sealing the inner edge of the reel plate 52 is not disposed so as to protrude from the bottom portion 36. Thus, it becomes possible to precisely center the reel plate 52 with respect to the reel hub 32 and insert-mold the reel plate 52. It should be noted that the annular portion sealing the inner edge of the reel plate 52 may be disposed so as to protrude from the bottom portion 36.

The reel hub 32 and the upper flange 40 of the reel 28 to which the reel plate 52 is fixed are integrally formed by pouring a resin material into the mold 70 through an appropriately disposed gate portion. Then, the reel 28 is obtained by joining the separately formed lower flange 38 to the joint surface 34B of the cylindrical portion 34 of the reel hub 32.

Next, the action of the present embodiment will be described.

In the recording tape cartridge 10 disposed with the reel 28 of the above-described configuration, when the magnetic tape T is not in use, the reel 28 is placed in a locked state where inadvertent rotation is prevented by the brake member 54 meshing with the engagement gear 44. Also, the opening 18 is closed off by the leader block 30.

When the magnetic tape T is to be used, the recording tape cartridge 10 is loaded in a bucket (not shown) of the drive device. When the recording tape cartridge 10 is loaded in the bucket, the bucket descends and the rotating shaft 80 of the drive device relatively approaches the case 12 from below (moves upward with respect to the case 12). When this happens, the projection 90 of the rotating shaft 80 enters the through-hole 46 of the reel 28, fits into the fitting surface 46A and pushes the release protrusion 60 of the brake member 54. Thus, the brake member 54 is pushed upward counter to the urging force of the compression coil spring 66 and the rotation-locked state of the reel 28 resulting from the brake member 54 is released.

When the rotating shaft 80 moves further upward, the drive gear 86 meshes with the reel gear 42. Then, when the positioning surface 88 of the rotating shaft 80 abuts against the reference surface 50A of the reel 28, the rotating shaft 80 moves further upward together with the reel 28. Then, when the bucket descends by a set stroke and stops, the movement of the rotating shaft 80 with respect to the case 12 stops, the reference surface 50A of the reel 28 abuts against the positioning surface 88 in the axial line direction and the reel 28 is positioned at a rotatable position risen inside the case 12.

The reel 28 is centered with respect to the rotating shaft 80 due to the projection 90 fitting in the fitting surface 46A of the through-hole 46 as described above. In this state, the reel 28 is retained at the rotating shaft 80 by the force with which the magnet 92 attracts the reel plate 52.

Due to the descent of the bucket, i.e., the recording tape cartridge 10 inside the drive device, the positioning pins of the drive device are respectively inserted into the positioning holes 24 and 26 of the case 12 and the positioning surfaces of the drive device abut against the positioning surfaces 24A and 26A of the case 12. Thus, the case 12 is positioned in the horizontal direction and the vertical direction with respect to the drive device.

When this happens, the pullout means of the drive device causes a pullout pin thereof (not shown) to engage with the engagement recess 30A of the leader block 30, pulls the leader block 30 out from the case 12 and guides the leader block 30 to the take-up reel of the drive device. Moreover, the leader block 30 is fitted into the take-up reel so that the arced surface 30B configures part of the take-up surface taking up the magnetic tape T. In this state, when the leader block 30 integrally rotates with the take-up reel, the magnetic tape T is pulled out from the case 12 through the opening 18 while being taken up at a reel hub of the take-up reel.

At this time, the reel 28 of the recording tape cartridge 10 synchronously rotates with the take-up reel due to the rotational force of the rotating shaft 80 transmitted by the drive gear 86 meshing with the reel gear 42. Then, information is recorded on the magnetic tape T or information recorded on the magnetic tape T is played back by a recording/playback head disposed along a predetermined tape path of the drive device.

When the magnetic tape T is to be rewound around the reel 28 and the leader block 30 is to be retained in the vicinity of the opening 18 in the case 12, the bucket in which the recording tape cartridge 10 is loaded is made to rise upward. When this happens, the meshed state between the reel gear 42 and the drive gear 86 is released, the projection 90 withdraws from the through-hole 46, the abutment between the release protrusion 60 and the projection 90 is released and the brake member 54 returns to the rotation-locked position where the brake gear 58 is made to mesh with the engagement gear 44 by the urging force of the compression coil spring 66. The reel 28 is also made to move downward by the urging force of the compression coil spring 66, causing the lower flange 38 thereof to abut against the annular rib 22 and return the reel gear 42 to its initial state where the reel gear 42 is exposed through the gear opening 20. In this state, the recording tape cartridge 10 is ejected from the bucket.

Here, because the reel gear 42 and the through-hole 46 of the reel 28 are formed by a common (identical) mold, the mutual axial centers of the annular reel gear 42 and the through-hole 46 positioned at the axial center of the reel 28 do not become skewed (e.g., are not affected by skewing between the movable mold 74 and the insert 76) as a result of positional skewing with respect to the partner mold as has conventionally been the situation. Thus, the axial center of the reel gear 42 and the axial center of the through-hole 46 can be aligned with high precision. For this reason, in the recording tape cartridge 10, an unnecessary force no longer acts on the through-hole 46 or the reel gear 42 in accompaniment with the rotational driving of the reel 28, and the reel 28 rotates stably.

In this manner, in the reel 28 pertaining to the present embodiment, the reel gear and the through-hole can be disposed at the hub with high precision. Also, in the recording tape cartridge 10 disposed with the reel 28, the magnetic tape T can be stably pulled out from the reel 28 and stably rewound around the reel 28.

Also, because the reference surface 50A is formed together with the reel gear 42 and the through-hole 46 by the common insert 76, the positional precision of the reference surface 50A with respect to the reel gear 42 and the through-hole 46 is high. In particular, because the verticality between the fitting surface 46A of the through-hole 46 and the reference surface 50A is precisely obtained, the axial center of the reel 28 is prevented from slanting with respect to the axial center of the rotating shaft 80 and the reel 28 rotates more stably. Thus, it also becomes possible to shorten the fitting surface 46A and thin the bottom portion 36. Moreover, by disposing the physically present reference surface 50A instead of a virtual reference surface resulting from the meshing of the reel gear 42 with the drive gear 86, the design and dimensional management of the reel 28 and the recording tape cartridge 10 become simple.

Additionally, by disposing the reference surface 50A, backlash arises between the reel gear 42 and the drive gear 86 and the centering function resulting from the meshing of the reel gear 42 with the drive gear 86 is reduced, but because the axial center of the through-hole 46 is aligned with high precision with the axial center of the reel gear 42 and the verticality between the fitting surface 46A and the reference surface 50A is high as described above, uncenteredness (mainly uncenteredness in the radial direction) of the reel 28 with respect to the rotating shaft 80 and slanting of the axial center are prevented, so that the reel 28 is rotatingly driven in a state where the reel 28 is precisely centered with respect to the rotating shaft 80. Namely, the centering function resulting from the meshing of the reel gear 42 with the drive gear 86 becomes unnecessary and the reel 28 can be stably rotatingly driven. For this reason, it is also possible to form the teeth of the reel gear 42 and the teeth of the drive gear 86 in shapes having meshing surfaces that are mutually parallel in the axial line direction and to improve a transmission torque.

Moreover, because the reel gear 42 and the fitting surface 46A of the through-hole 46 (and the reference surface 50A) are formed by the insert 76 rather than the fixed mold 72, the reel gear 42 and the through-hole 46 can be made common so that reels 28 having upper flanges 40 of different sizes can be easily obtained. Conversely, by making common the upper flange 40 and using inserts 76 of different shapes, reels 28 having reel gears 42 and through-holes 46 of different sizes and different dispositions can be easily obtained. Namely, by using the insert 76, it becomes possible to easily accommodate changes in the design of the reel 28.

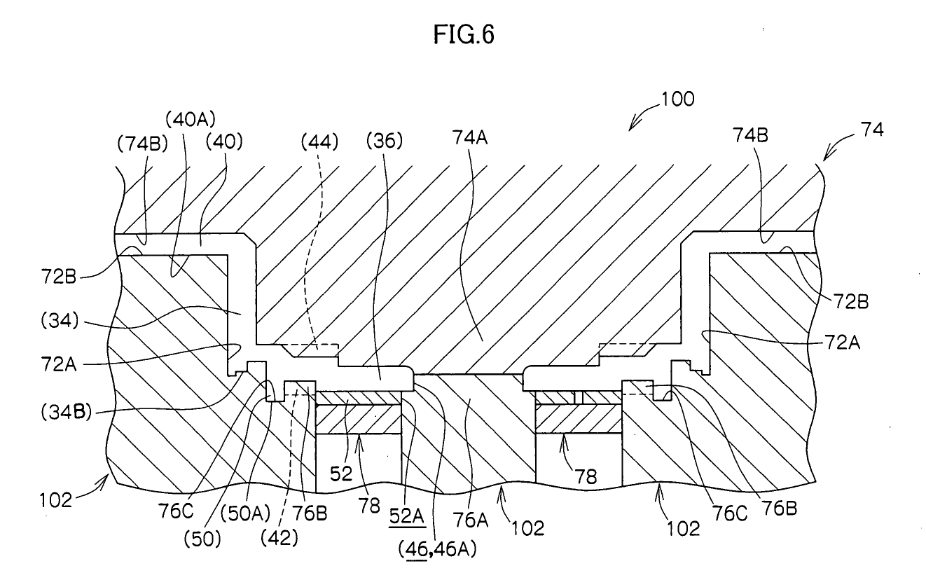

Although an example was described in the preceding embodiment where the reel hub 32 and the upper flange 40 of the reel 28 were formed by the mold 70, the present invention is not limited thereto. For example, the invention may also have configurations pertaining to the modified examples shown in FIGS. 6 to FIGS. 8A and 8B. In the following description, identical reference numerals will be given to parts/portions that are fundamentally identical to those of the above-described embodiment or the aforementioned configuration, and description of those parts/portions will be omitted.

FIG. 6 shows a mold 100 pertaining to a first modified example. As shown in this drawing, the mold 100 is similar to the mold 70 in that it is disposed with the movable mold 74 and the insert 78, but the mold 100 is different from the mold 70 in that the mold 100 is disposed with a fixed mold 102 instead of the fixed mold 72 and the insert 76. The fixed mold 102 includes the cylindrical portion outer surface forming portion 72A, the opposing surface forming portion 72B, the hole portion forming portion 76A, the reel gear forming portion 76B and the reference portion forming portion 76C, which are integrally formed. Namely, the fixed mold 102 is formed as if the fixed mold 72 and the insert 76 were integrated.

Due to the mold 100, the outer peripheral surface 34A and joint surface 34B of the cylindrical portion 34 and the opposing surface 40A of the upper flange 40 are formed together with the rear gear 42, the through-hole 46 and the reference surface 50A by the common fixed mold 102. For this reason, the axial center of the outer peripheral surface 34A of the cylindrical portion 34 of the hub 32 around which is wound the magnetic tape T is aligned with high precision with the axial centers of the rear gear 42 and the through-hole 46. Thus, the roundness of the outer peripheral surface 34A with respect to the rotational center of the reel 28 becomes higher and the magnetic tape T is more stably pulled out and rewound in accompaniment with the rotation of the reel 28.

Moreover, because the opposing surface 40A of the upper flange 40, which is the surface against which the magnetic tape T abuts, is obtained with high precision with respect to the reference surface 50A, surface vibration of the opposing surface 40A at the time the reel 28 is rotatingly driven is suppressed and the guidability of the magnetic tape T becomes excellent. In particular, because the dimensional precision between the opposing surface 40A and the joint surface 34B to which is joined the lower flange 38 is also improved, fluctuations in the interval of opposition between the upper flange 40 and the lower flange 38 are eliminated and the guidability of the magnetic tape T is further improved. Moreover, because the dimensional precision with respect to the reference surface 50A of the lower flange 38 welded to the joint surface 34B is improved, the positional precision with respect to the reference surface 50A of the lower flange 38 resting on the bottom panel 16A (annular rib 22) of the case 12 when the magnetic tape T is not in use becomes higher and the reel 28 can be precisely raised with respect to the case 12 when the reel 28 is rotatingly driven.

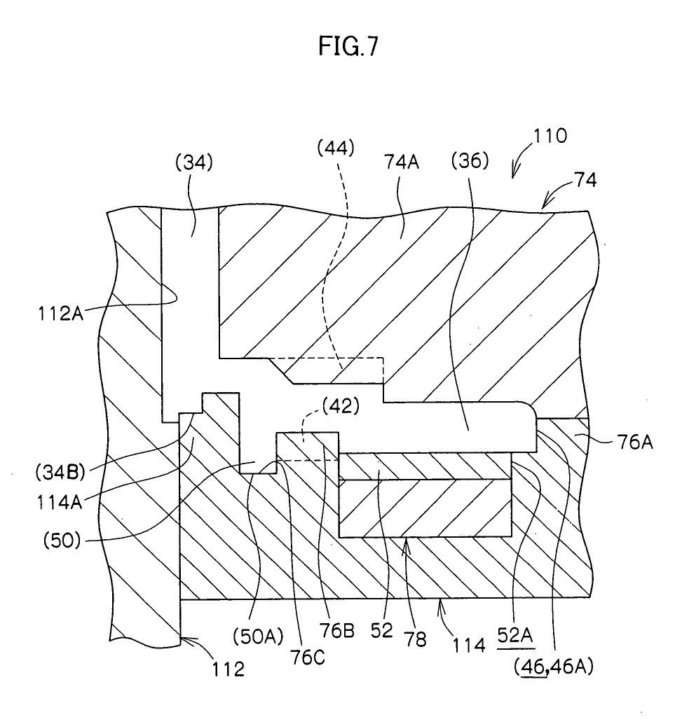

FIG. 7 shows a mold 110 pertaining to a second modified example. As shown in this drawing, the mold 110 is similar to the mold 70 in that it is disposed with the movable mold 74 and the insert 78, but the mold 110 is different from the mold 70 in that the mold 110 is respectively disposed with a fixed mold 112 and an insert 114 instead of the fixed mold 72 and the insert 76. The fixed mold 112 includes a cylindrical portion outer surface forming portion 112A, for mainly forming the outer peripheral surface 34A of the reel hub 32, and the opposing surface forming portion 72B (not shown), which are integrally formed. In contrast to the cylindrical portion outer surface forming portion 72A, the cylindrical portion outer surface forming portion 112A is not disposed with the portion forming the joint surface 34B. Also, the insert 114 includes the hole portion forming portion 76A, the reel gear forming portion 76B, the reference portion forming portion 76C and a joint surface forming portion 114A for forming the joint surface 34B, which are integrally formed.

Due to the mold 110, the joint surface 34B is formed together with the reel gear 42, the through-hole 46 and the reference surface 50A by the common insert 114. For this reason, the height of the joint surface 34B with respect to the reference surface 50A is precisely obtained, and the dimensional precision with respect to the reference surface 50A of the lower flange 38 welded to the joint surface 34B is improved. Thus, the positional precision with respect to the reference surface 50A of the lower flange 38 resting on the bottom panel 16A (annular rib 22) of the case 12 when the magnetic tape T is not in use is high, and the reel 28 can be precisely raised with respect to the case 12 when the reel 28 is rotatingly driven.

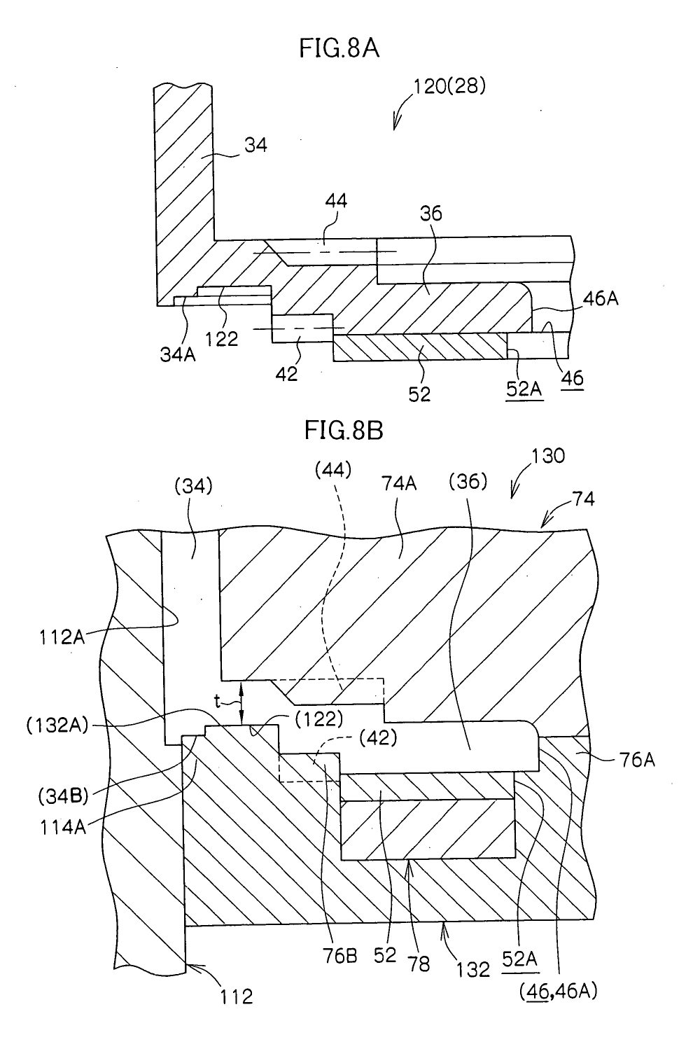

FIG. 8A shows a partial enlarged view of a reel hub 120 that pertains to a third modified example and configures the reel 28. As shown in this drawing, the reel hub 120 is not disposed with the reference projection 50, but a recessed surface at the radial-direction outer side of the reel gear 42 serves as a reference surface 122. Although not shown, the reference surface 122 abuts against end surfaces of plural positioning projections that are annularly divided in the circumferential direction and project from the rotating table 84 of the rotating shaft 80. The remaining configuration of the reel hub 120 is the same as that of the reel hub 32.

As shown in FIG. 8B, a mold 130 forming the reel hub 120 and the upper flange 40 is similar to the mold 110 pertaining to the second modified example in that the mold 130 is disposed with the movable mold 74, the insert 78 and the fixed mold 112, but the mold 130 is different from the mold 110 in that the mold 130 is disposed with an insert 132 in place of the insert 114. The insert 132 includes, in place of the reference portion forming portion 76C, an integrally disposed reference portion forming portion 132A for forming the reference surface 122 of the reel hub 120. The remaining configuration of the insert 132 is the same as that of the insert 114.

Because the reference projection 50 projects from the bottom portion 36 in the reel 28 including the reel hub 120 formed by the mold 130, the plate thickness t of the bottom portion 36 can be made even, the fluidity of the resin material is improved and the moldability of the reel hub 120 (and the upper flange 40) is improved. Other effects are the same as those of the second modified example.

It should be noted that, although preferable configurations were described where the reference surface 50A was formed together with the reel gear 42 and the through-hole 46 by a common mold (inserts 76, 114, 132, fixed mold 102) in the above-described embodiment and modified examples, the invention suffices as long as the reel gear 42 and the through-hole 46 are formed by a common mold. Thus, the reel pertaining to the invention is not limited to the reel 28 of the above-described configuration (shape), and it suffices as long as the reel gear corresponding to the reel gear 42 and the hole portion corresponding to the through-hole 46 are disposed at the reel hub 32 (120). It also goes without saying that the mold for forming the reel is not limited to the molds 70, 100, 110 and 130.

Also, although a preferable configuration was described where the reel was disposed with the through-hole 46 penetrating the bottom portion 36 as a hole portion in the above-described embodiment and modified examples, the invention is not limited thereto. It suffices as long as the hole portion is disposed in the lower surface of the bottom portion 36 so that the projection 90 fits therein and is centered. This configuration can be applied to a recording tape cartridge of a configuration where the locked state of the brake member 54 is operated by another portion (e.g., a configuration disposed with a clutch member where leg portions pushed and operated by the teeth tips of the drive gear 86 are exposed at reel gear formation sites, or a configuration where an operational portion operated by a release portion independent of the rotating shaft 80 of the drive device is exposed through a window portion disposed in a peripheral wall of the case 12).

Moreover, although a preferable configuration was described where the reel 28 included the reel plate 52 in the above-described embodiment and modified examples, the invention is not limited thereto. For example, it is also possible to configure the reel 28 so that it does not include the reel plate 52. Also, in the configuration where the reel 28 includes the reel plate 52, the reel plate 52 may be attached later by caulking without being insert-molded. Alternatively, in an instance where the reel plate is insert-molded, the reel plate may be formed by insert-molding (e.g., by the insert 76) without using the insert 78.

Also, although a preferable configuration was described where the upper flange 40 was integrally formed with the reel hub 32 in the above-described embodiment and modified examples, the invention is not limited thereto. For example, the invention may also be configured so that the lower flange 38 is integrally formed with the reel hub 32 and the upper flange 40 is attached to the reel hub 32 by welding, or may be configured so that the upper and lower flanges 40 and 38 are both attached to the reel hub 32 by welding. Even in a configuration where the lower flange 38 is integrally formed with the reel hub 32, the reel gear 42, the through-hole 46 and the reference surface 50A can be formed using the inserts 76, 114 and 132.

Also, although a preferable configuration was described where the reference surfaces 50A and 122 serving as reference portions were disposed at the radial-direction outer side of the reel gear 42 in the above-described embodiment and modified examples, the invention is not limited thereto. For example, the reference surfaces 50A (reference projection 50) and 122 may also be disposed at the radial-direction inner side of the reel gear.

Moreover, although a preferable configuration was described where the reel 28 was applied to the so-called single-reel recording tape cartridge 10 where only one reel was housed inside the case 12 in the above-described embodiment and modified examples, the invention is not limited thereto. For example, the reel 28 may also be applied to one or both reels of a two-reel recording tape cartridge housing two reels: i.e., a wind-off reel and a take-up reel. Also, the single-reel recording tape cartridge of the invention is not limited to the recording tape cartridge 10. For example, the recording tape cartridge of the invention may also be disposed with a leader tape or a leader pin, as the leader member for pulling out the magnetic tape T, in place of the leader block 30. Thus, the recording tape cartridge of the invention is not limited to a configuration where the opening 18 for pulling out the magnetic tape T is closed off by the leader block 30 when the magnetic tape T is not in use. For example, the recording tape cartridge of the invention may also have a configuration where the opening corresponding to the opening 18 is closed off by a blocking member (e.g., a sliding door or a rotating door) other than the leader member.

Moreover, although a configuration was described where the magnetic tape T was used as the recording tape in the above-described embodiment, the invention is not limited thereto. It suffices as long as the recording tape is understood to be a long tape-like information recording and playback medium on which information can be recorded and from which recorded information can be played back. It goes without saying that the recording tape cartridge pertaining to the invention is applicable to recording tapes of all recording and playback formats.

1. A reel disposed with a hub that includes a bottom portion, which reel is formed in a cylindrical shape and around whose outer peripheral surface recording tape is wound, with an annular reel gear formed coaxially with the cylindrical shape of the hub at an outer side of the bottom portion of the hub and a hole portion opening to an outer surface side of an axial center portion of the bottom portion being integrally formed with the reel by resin molding, and with the reel being rotatingly driven by a rotating shaft of a drive device in a state where a projection disposed at an axial center portion of the rotating shaft fits into and is centered in the hole portion and a drive gear of the rotating shaft is meshed with the reel gear,
wherein the reel gear and an inner surface of the hole portion are formed by a reel gear forming portion and a hole portion forming portion integrally disposed in a common mold.

2. The reel of claim 1, further including a reference portion that is disposed at an outer side of the bottom portion of the hub and is for positioning the reel in the axial line direction, by abutting against a positioning portion of the rotating shaft,
wherein the reference portion is formed by a reference portion forming portion integrally disposed in the common mold.

3. The reel of claim 1, wherein the common mold is an insert mold where the reel gear forming portion and the hole portion forming portion are integrally disposed and the reel gear and the hole portion are formed by using the insert mold.

4. The reel of claim 2, wherein the common mold is an insert mold where the reel gear forming portion, the hole portion forming portion and the reference portion forming portion are integrally disposed and the reel gear, the hole portion and the reference portion are formed by using the insert mold.

5. The reel of claim 1, further including a first flange attached to an end portion of a bottom portion side of the hub and a second flange integrally formed by resin molding at an open end side of the hub opposite from the bottom portion side, wherein the outer peripheral surface of the hub and a surface of the second flange opposing the first flange are formed by a hub outer surface forming portion and an opposing surface forming portion integrally disposed in the common mold.

6. The reel of claim 1, wherein the reel is rotatably housed inside a case of a recording tape cartridge in a state where the reel gear and the hole portion are exposed.

7. A recording tape cartridge that houses a reel, the reel including a bottomed cylindrical hub around whose outer peripheral surface recording tape is wound, with an annular reel gear that is driven by a drive device when the recording tape cartridge is loaded in the drive device and the reel is rotated and a hole including an inner surface for defining a rotational center of the reel being formed in an outer portion surface of the bottom of the hub, wherein the reel gear and the hole are resin-molded by a single mold.

8. The recording tape cartridge of claim 7, further including a reference portion that is formed at the outer portion surface of the bottom of the hub and abuts against part of the drive device when the recording tape cartridge is loaded in the drive device and the reel is rotated so that the reference portion provides a reference surface for positioning the reel in the rotational axial direction of the reel, wherein the reference portion is formed together with the reel gear and the hole by the single mold.

9. The recording tape cartridge of claim 8, wherein the reference surface is formed at a position projecting from the reel gear.

10. The recording tape cartridge of claim 8, wherein the reference surface is formed at a position withdrawn from the reel gear.

11. The recording tape cartridge of claim 7, wherein the reel is resin-molded using at least a movable mold and a fixed mold, and the single mold is the fixed mold.

12. The recording tape cartridge of claim 7, wherein the reel is resin-molded using at least an insert and the single mold is the insert.

13. The recording tape cartridge of claim 7, wherein the reel further includes a first flange attached to an end portion of a bottom portion side of the hub and a second flange integrally formed with the hub by resin molding at an open end side of the hub opposite from the bottom portion side, with the outer peripheral surface of the hub and a surface of the second flange facing the first flange being formed by the single mold.

14. The recording tape cartridge of claim 7, further including a case housing the reel, wherein the single reel is rotatably housed in a state where the reel gear and the hole are exposed through the case.

15. A method of manufacturing a reel housed in a recording tape cartridge, the reel including a bottomed cylindrical hub around whose outer peripheral surface recording tape is wound, with an annular reel gear that is driven by a drive device when the recording tape cartridge is loaded in a drive device and the reel is rotated and a hole including an inner surface for defining a rotational center of the reel being formed in an outer portion surface of the bottom of the hub, the method including at least the steps of providing hub-use molds and injecting a resin material into the molds to resin-mold the hub, wherein the reel gear and the hole are both formed by a single mold.

16. The method of manufacturing the recording tape-use reel of claim 15, wherein the reel further includes a reference portion that is formed at the outer portion surface of the bottom of the hub and abuts against part of the drive device when the recording tape cartridge is loaded in the drive device and the reel is rotated so that the reference portion provides a reference surface for positioning the reel in the rotational axial direction of the reel, wherein the reference portion is formed together with the reel gear and the hole by the single mold.

17. The method of manufacturing the recording tape-use reel of claim 15, wherein the mold includes at least a movable mold and a fixed mold, and the single mold is the fixed mold.

18. The method of manufacturing the recording tape-use reel of claim 15, wherein the mold includes at least an insert and the single mold is the insert.

19. The method of manufacturing the recording tape-use reel of claim 15, wherein the reel further includes a first flange attached to an end portion of a bottom portion side of the hub and a second flange integrally formed with the hub by resin molding at an open end side of the hub opposite from the bottom portion side, with the outer peripheral surface of the hub and a surface of the second flange facing the first flange being formed by the single mold.

20. The method of manufacturing the recording tape-use reel of claim 15, wherein the recording tape cartridge further includes a case housing the reel, with the single reel being rotatably housed in a state where the reel gear and the hole are exposed through the case.
